(19) United States
(12) Patent Application Publication
(10) Pub. No.: US 2016/0089803 A1
(43) Pub. Date: Mar. 31, 2016

(54) SMALL FOOD CUTTING DEVICE, SYSTEM, AND METHOD

(71) Applicant: Robert E. Fox, Shelton, CT (US)

(72) Inventor: Robert E. Fox, Shelton, CT (US)

(21) Appl. No.: 14/498,368

(22) Filed: Sep. 26, 2014

(51) Int. Cl. B26B 29/06

(52) U.S. Cl. CPC B26B 29/063

(57) ABSTRACT

A small food cutting device comprising: a lid, the lid comprising: an inner ceiling; a lid wall enclosing the inner ceiling; a base, configured to mate with the lid, the base comprising: an inner floor; a base wall enclosing the inner floor; and wherein the base is configured to hold a plurality of small foods, with the lid laying on top of the plurality of small foods and forming a gap between the lid and the base, the gap generally aligned to the mid-height of the small foods. A small food cutting system comprising: a base, the base comprising: an inner floor; a base wall enclosing the inner floor; a plurality of small foods located generally on the inner floor and contained within the base wall; a lid placed on top of the plurality of small foods, the lid comprising: an inner ceiling; a lid wall enclosing the inner ceiling; a gap formed between the lid and the base, the gap generally aligned to the mid-height of the small foods; and a knife, configured to slice the small foods generally in half through the gap. A method of cutting small foods with small food cutting device, the method comprising: placing a plurality of small foods on the inner floor of the base of the small food cutting device; placing a lid on top of the plurality of small foods located in the base; leaving a small gap G between the lid and the base, and generally aligned with the mid-height of the small foods; holding the lid by a handle; cutting the small foods generally in half with a knife through the small gap G; removing the lid; and using the cut small foods.

### TECHNICAL FIELD

The present invention relates to kitchen utensils, and more particularly to a small food cutting device, system, and method.

### BACKGROUND

Cooking is a passionate endeavor for many, including amateur and professional chefs. Preparing and eating food is basic to survival, thus cooks of all skill levels strive to make it an enjoyable experience through various techniques and combination of flavors, herbs, and spices.

One of the most demanding aspects to cooking lies in prepping the ingredients for a particular recipe. This requires tedious and time consuming chopping and slicing of vegetables, fruits, breads, meat, and other food items that can be relatively tiresome and dangerous if one is not careful with a knife, especially in a restaurant environment where food must be prepared in mass quantities. Some ingredients require more effort or time due to the special handling needs and/or presentation. Food is enjoyed with the eyes as well as the mouth. For example, if it is desired to cut grapes in half, it generally requires the cook to slice each individual grape. More may be cut at a time if the cook is especially dexterous—but may also be more dangerous leading to cuts on the hands of the cook. In either case, this is a tedious, repetitive process lacking a solution. Thus, it would be a benefit in the art to provide a device where a plurality of foodstuffs may be cut in a safe and expeditious manner.

Thus, there is a need for a small food cutting device, system, and method that overcomes the above and other disadvantages.

### SUMMARY OF THE INVENTION

The disclosed invention relates to a small food cutting device comprising: a lid, the lid comprising: an inner ceiling; a lid wall enclosing the inner ceiling; a base, configured to mate with the lid, the base comprising: an inner floor; a base wall enclosing the inner floor; and wherein the base is configured to hold a plurality of small foods, with the lid laying on top of the plurality of small foods and forming a gap between the lid and the base, the gap generally aligned to the mid-height of the small foods.

The disclosed invention also relates to a small food cutting system comprising: a base, the base comprising: an inner floor; a base wall enclosing the inner floor; a plurality of small foods located generally on the inner floor and contained within the base wall; a lid placed on top of the plurality of small foods, the lid comprising: an inner ceiling; a lid wall enclosing the inner ceiling; a gap formed between the lid and the base, the gap generally aligned to the mid-height of the small foods; and a knife, configured to slice the small foods generally in half through the gap.

In addition, the disclosed invention relates to a method of cutting small foods with small food cutting device, the method comprising: placing a plurality of small foods on the inner floor of the base of the small food cutting device; placing a lid on top of the plurality of small foods located in the base; leaving a small gap G between the lid and the base, and generally aligned with the mid-height of the small foods; holding the lid by a handle; cutting the small foods generally in half with a knife through the small gap G; removing the lid; and using the cut small foods.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of the small food cutting device;

FIG. 2 is a perspective view of the small food cutting device from FIG. 1, with the lid inserted into the base;

FIG. 3 is a top view of the lid and the base;

FIG. 4 is a side view of the lid and the base;

FIG. 5 is a bottom view of the lid and the base;

FIG. 6 is a view showing small foods placed into the base;

FIG. 7 is a view showing the lid placed on top of the small foods; and

FIG. 8 is a flowchart showing one disclosed method.

### DETAILED DESCRIPTION

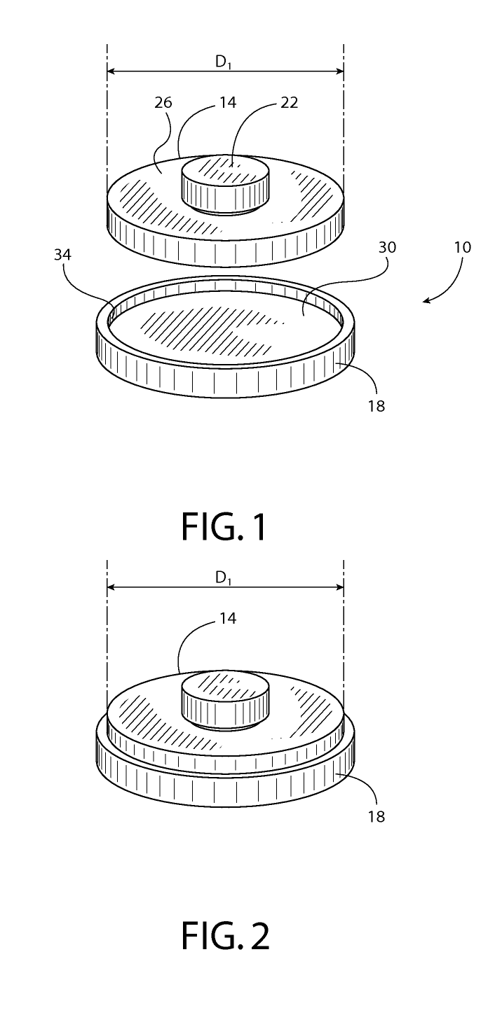

FIG. 1 is a perspective view of the small food cutting device 10. The device 10 comprises a lid 14 and a base 18. The lid 14 may have a handle 22 that extends from the top surface 26 of the lid 14. The base comprises an inner floor 30. The floor 30 is enclosed by a base wall 34 that generally forms a perimeter about the inner floor 30. The base wall 34 may extend up from about 1/10 of an inch to about 1 inch from the floor 30. Similarly, the lid comprises an inner ceiling 38, see FIG. 4. The inner ceiling 38 is enclosed by a lid wall 42 that generally forms a perimeter about the inner ceiling 38. The lid wall 42 may extend down from about 1/10 of an inch to about 1 inch from the inner ceiling 38. In this embodiment, the lid 14 may have an outer diameter D1. The base may have an inner diameter D₂.

FIG. 2 is a perspective view showing how the lid 14 may fit within the base 18. In this embodiment D₁ is less than D₂, thereby allowing the lid 14 to fit within the base 18.

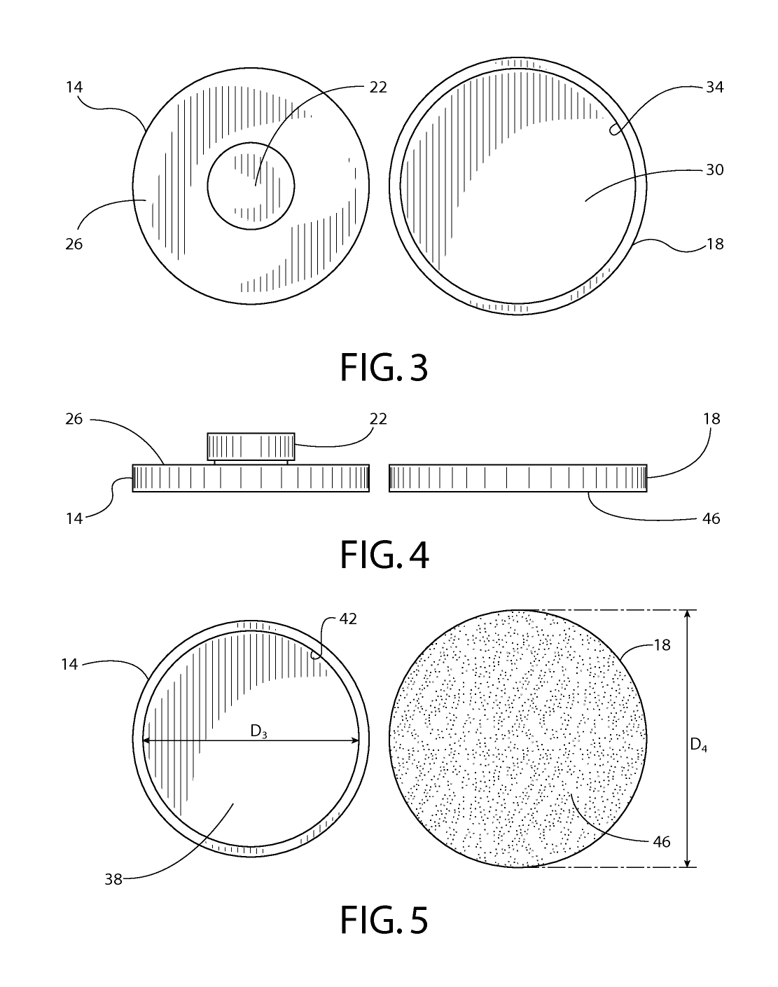

FIG. 3 is a top view of the lid 14 and the base 18.

FIG. 4 is a side view of the lid 14 and base 18.

FIG. 5 is a bottom view of the lid 14 and the base 18. In one embodiment the base 18 may have a non-skid, non-slip, or slip resistant material located on the bottom surface 46 of the base 18. In this embodiment, the lid 14 may have an inner diameter D₃. The base 18 may have an outer diameter D₄. In another embodiment, the base 18 may fit within the lid 14, such that D₄ is smaller than D₃.

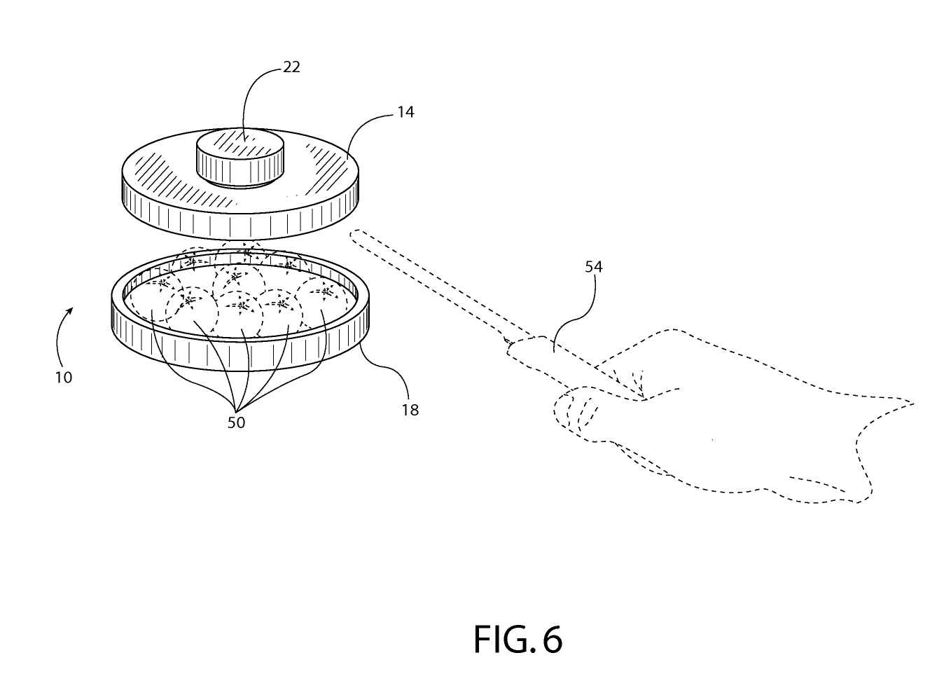

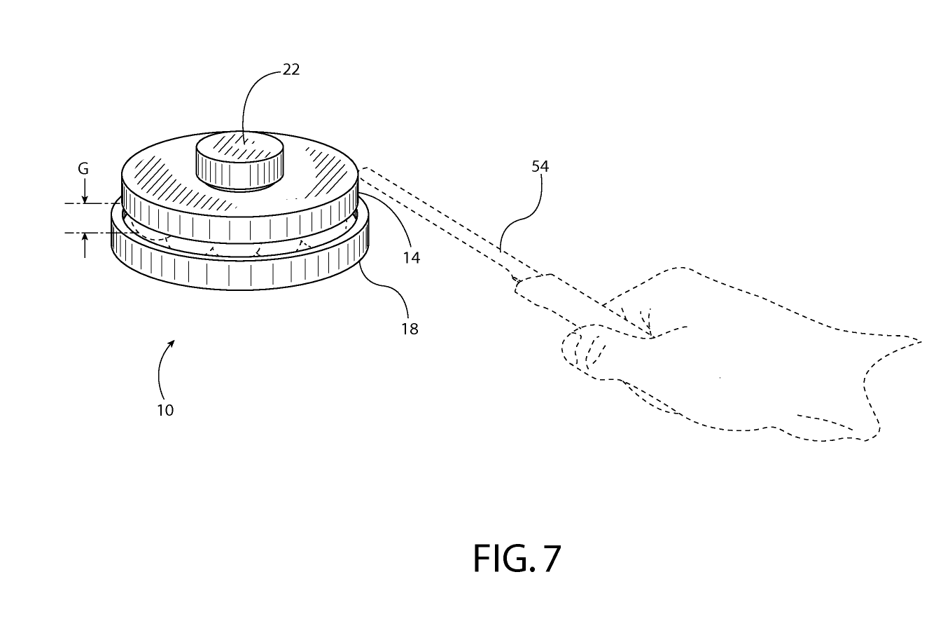

FIG. 6 shows one method of using the small food cutting device 10. Small foods 50 may be placed in the base 18, namely, in the volume defined by the inner floor 30 and base wall 34. The size of the small food cutting device 10 may be configured so that generally the small food 50 will keep the lid 14 a small distance apart from the base 18 when the lid is placed on top of the small food 50 located in the base 18. FIG. 7 shows the lid 14 placed on top of the small food 50. When the small food cutting device 10 and/or small food 50 are properly sized, there will be a small gap G between the lid 14 and base 18. When the small food cutting device 10 and/or small food 50 are properly sized, the small gap G will generally be lined up at mid-height of each of the small foods, such that when a knife is placed within the gap to cut the small foods, the small foods will generally be cut in half. With one hand a user may hold the handle 22 of the lid 14, and with the other hand, the user may take a knife 54 and make a cut in the gap G, thereby cutting all the small food 50 located between the lid 14 and the base 18. The small gap G may range in height between about ¼ inch to about 1 and ½ inches, or more.

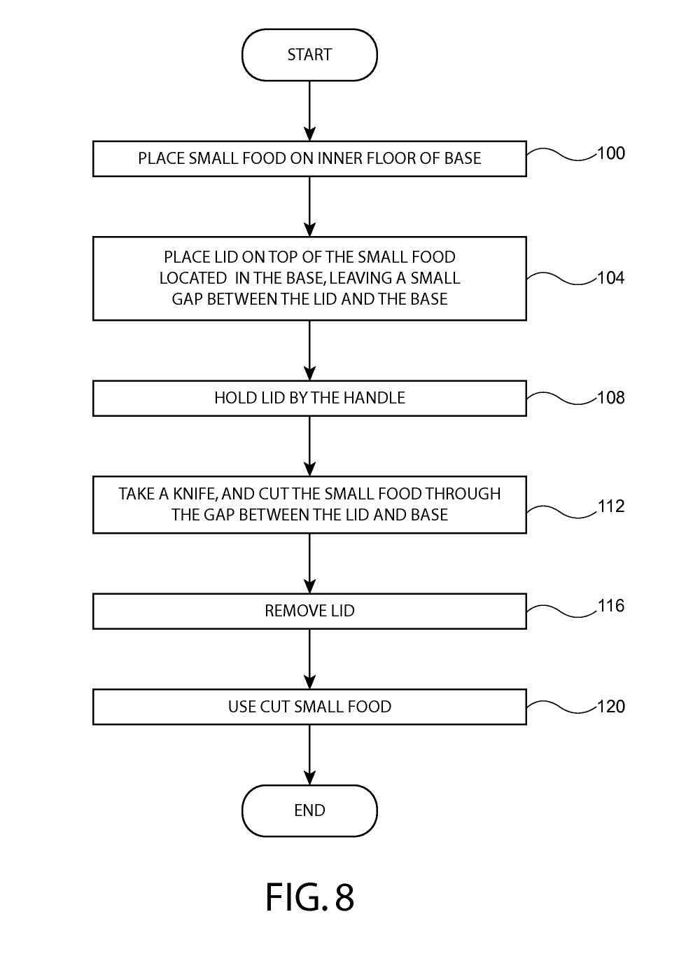

FIG. 8 is a flowchart showing one method of using the disclosed device and system. At act 100, a user places small food on the inner floor of the base. At act 104, the user places the lid on top of the small food located in the base, being sure to leave a small gap G between the lid and the base. At act 108, the user holds the lid by the handle. At act 112, the user takes a knife, and cuts the small food through the gap G between the lid and the base. At act 116, the user removes the lid, and at act 120, the cut food is ready to be used.

This invention has many advantages. The disclosed small food cutting device may be used to cut small foods such as, but not limited to vegetables, fruit, cherry tomatoes, grapes, grape tomatoes, etc. Generally, when one wants to cut these small vegetables and fruit in half one must cut each piece of food individually. The disclosed small food cutting device allows one to cut such small foods by multiples at a time, such as 10 at a time, or 15 at a time, or 20 at a time or more. Because both the lid and the base have walls that form a chamber, the small foods are prevented from sliding out of the device when cutting the small food. The small food cutting device may be made out of any suitable material such as plastic, fiberglass, metal, wood. The lid of the small food cutting device should be configured such that the weight of the lid will not bruise or squash the small food. The advantages of this device are that it allows one to quickly cut many small items of food, such as vegetables and fruits, without having to cut them each one at a time. In addition, the lid may be configured to slide into the base, when not in use, to minimize the storage size of the device.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A small food cutting device comprising:
a lid, the lid comprising:
an inner ceiling;
a lid wall enclosing the inner ceiling;
a base, configured to mate with the lid, the base comprising:
an inner floor;
a base wall enclosing the inner floor; and
wherein the base is configured to hold a plurality of small foods, with the lid laying on top of the plurality of small foods and forming a gap between the lid and the base, the gap generally aligned to the mid-height of the small foods.

2. The small food cutting device of claim 1, further comprising:
a handle extending up from the top surface of the lid.

3. The small food cutting device of claim 1, wherein the lid has an outer diameter D1, and inner diameter D3, and the base has an inner diameter D2, and an outer diameter D4, and wherein D1 is smaller than D2 and the lid fits inside of the base.

4. The small food cutting device of claim 1, wherein the lid has an outer diameter D1, and inner diameter D3, and the base has an inner diameter D2, and an outer diameter D4, and wherein D4 is smaller than D3 and the base fits inside of the lid.

5. A small food cutting system comprising:
a base, the base comprising:
an inner floor;
a base wall enclosing the inner floor;
a plurality of small foods located generally on the inner floor and contained within the base wall;
a lid placed on top of the plurality of small foods, the lid comprising:
an inner ceiling;
a lid wall enclosing the inner ceiling;
a gap formed between the lid and the base, the gap generally aligned to the mid-height of the small foods; and
a knife, configured to slice the small foods generally in half through the gap.

6. The small food cutting system of claim 5, further comprising:
a handle extending up from the top surface of the lid.

7. The small food cutting system of claim 5, wherein the lid has an outer diameter D1, and inner diameter D3, and the base has an inner diameter D2, and an outer diameter D4, and wherein D1 is smaller than D2 and the lid fits inside of the base.

8. The small food cutting system of claim 5, wherein the lid has an outer diameter D1, and inner diameter D3, and the base has an inner diameter D2, and an outer diameter D4, and wherein D4 is smaller than D3 and the base fits inside of the lid.

9. A method of cutting small foods with small food cutting device, the method comprising:
placing a plurality of small foods on the inner floor of the base of the small food cutting device;
placing a lid on top of the plurality of small foods located in the base;
leaving a small gap G between the lid and the base, and generally aligned with the mid-height of the small foods;
holding the lid by a handle;
cutting the small foods generally in half with a knife through the small gap G;
removing the lid; and
using the cut small foods.
